(19) United States
(12) Patent Application Publication
(10) Pub. No.: US 2010/0142379 A1
(43) Pub. Date: Jun. 10, 2010

(54) METHOD FOR CLASSIFYING PACKET ON MOBILE TERMINAL

(75) Inventors: Junsik KIM, Seoul (KR); Namhoon Park, Daejeon-city (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon-City (KR)

(21) Appl. No.: 12/631,223

(22) Filed: Dec. 4, 2009

(30) Foreign Application Priority Data
Dec. 5, 2008 (KR) 10-2008-0123478
Nov. 13, 2009 (KR) 10-2009-0109609

(51) Int. Cl. H04L 12/26

(52) U.S. Cl. 370/241

(57) ABSTRACT

A method for classifying a packet on a mobile terminal according to the present invention includes: receiving a transmission request of IP packet data from an upper layer; determining whether there is a packet classifier for classifying the IP packet data; generating the packet classifier by obtaining a service grade and a service parameter for the IP packet data if it is determined that there is no packet classifier for classifying the IP packet data; and requesting a connection identifier of the generated packet classifier to transmit the IP packet data.

### RELATED APPLICATIONS

The present application claims priority to Korean Patent Application Serial Number 10-2008-0123478, filed on Dec. 5, 2008 and Korean Patent Application Serial Number 10-2009-0109609, filed on Nov. 13, 2009, the entirety of which are hereby incorporated by reference.

### BACKGROUND OF THE INVENTION

1. Field of the Invention

The present invention relates to a method for designing a packet classifier on a mobile terminal. More specifically, the present invention relates to a method for generating a packet classifier that classifies an IP packet transmitted and received between a terminal and a base station into a transmission channel of a lower layer on a multi SDR terminal and a method for classifying a packet.

2. Description of the Related Art

Due to the development of a mobile communication industry and the increased utility of wire data broadcasting and Internet service by a user, radio broadcasting and data service in various schemes in addition to audio services such as a wireless LAN, a GPS, an EV-DO, a DMB, a Wibro, an HSDPA, etc., are being provided by providers.

Since each service provides different offer coverage, purpose, performance, costs and services, which have the same contents, can be provided in the same place by various radio access scheme, the user should selects and use data service through an appropriate radio access scheme in accordance with his or her own purpose, including mobile communication.

The demand for a multi mode system as various wireless data services, which can be selected by the user, has expanded and thus, the utility value of the software defined radio (SDR) system, which can flexibly cope with the user demand, is increasing.

In the case of the SDR system that mainly provides the data services, it can be configured by only changing the software of a radio access module for multi mode services. Therefore, the wireless data service selected according to the demand of the user can be easily used under an environment that provides various access to radio schemes without needing to change the hardware. At this time, one terminal provides several wireless data services, but the terminal used by the user should provide the same application programs and services regardless of the types of wire data services. Thereby, a convergence layer is generated on a call processing protocol that is provided in a general wireless standard, which generally performs a function of classifying packets according to an IP and compressing headers to support QoS in order to interface with the upper application program.

When software communication architecture (SCA) middleware recommended as the standard for an SDR system is applied, each application software component should use a communication port that is provided in the common object request broker architecture (CORBA) based on an SCA.

Communication protocol implementation software is getting quicker in speed and lighter in weight, while system implementation using middleware uses an SCA port that standardizes software. However, the system implementation using middleware is relatively degrades speed, which is a serious obstacle in applying an SDR platform to a communication system that aims at high-speed data processing.

Further, by configuring the communication protocol using component based software, configuration becomes more complicated and operation becomes more difficult, as compared to the existing communication software.

Since the SDR system is operated based on the software component, the component operation and management may be considered as important technical elements. In addition, each radio protocol becomes componentization, which performs the port communication on the middleware. Therefore, a delay on the modem as well as a delay on a mode upper protocol should be minimized to satisfy the required service quality characteristics.

The existing typical scheme newly sets connections on the component in which the radio protocol is implemented whenever connections or logic channels for services are generated and transmits data through the port.

In the case of the radio protocol, various wireless channels are provided so that services provide data quality and data are separated from the upper layer according to the channels. With typical implementation, this generates ports that consume too much communication time between protocol components, thus causing delay to the port communication, which has a negative effect on the overall performance.

Further, in order to stably support the high-speed wireless data communication services, various retransmission schemes are used. In the case of retransmission that has an effect on the upper protocol, considerable internal traffic are generated, and as a result, a separate control is required. This may classified into the change in the initial configuration and radio access scheme and the operation of maintenance. It is expected that the next-generation wireless communication system can differentially provide high-speed and low-speed services according to the purpose and thus, an operation scheme for the above will also required.

### SUMMARY OF THE INVENTION

The present invention proposes to solve the above problems.

It is an object of the present invention to perform high-speed data processing without being a cause in performance delay on an SDR terminal by designing a general-purpose packet classifier that can be used while allowing change in its own shape by using a configuration manager according to wireless data communication services driven on an SDR terminal and designing the packet classifier, which is a management subject of traffic data, to dynamically generate or remove the packet classifier based on configuration information according to QoS grade and applications.

A method for classifying a packet on a mobile terminal includes: receiving a transmission request of IP packet data from an upper layer; determining whether there is a packet classifier for classifying the IP packet data; generating the packet classifier by obtaining a service grade and a service parameter for the IP packet data if it is determined that there is no packet classifier for classifying the IP packet data; and requesting a connection identifier of the generated packet classifier to transmit the IP packet data.

In particular, the generating the packet classifier is performed by obtaining a service grade and a service quality parameter of the IP packet data from a service rule profile; and generating the packet classifier using the obtained service grade and service quality parameter.

In addition, the service rule profile further includes an identifier, a protocol type, and a server side port number.

Further, the generating the packet classifier using the obtained service grade and service quality parameter is performed by determining whether there is the connection identifier supporting the service grade obtained from the service rule profile; and newly generating a packet classifier using the obtained service grade and service quality parameter if it is determined that there is no connection identifier supporting the service grade.

In addition, the method for classifying a packet on a mobile terminal adds a packet classifier to the corresponding connection identifier if it is determined that there is the connection identifier supporting the service grade.

Moreover, the method for classifying a packet on a mobile terminal further includes requesting the corresponding connection identifier to transmit the IP packet data, if it is determined that there is the packet classifier for classifying the IP packet data.

A method for generating a packet classifier on a mobile terminal includes: receiving a transmission request of IP packet data from an upper layer; obtaining a service grade and a service quality parameter for the IP packet data from a specific service rule profile; and generating a packet classifier using the obtained service grade and service quality parameter.

In addition, the service rule profile further includes an identifier, a protocol type, and a server side port number.

Further, the generating the packet classifier is performed by determining whether there is the connection identifier supporting the service grade obtained from the service rule profile; and generating a packet classifier using the obtained service grade and service quality parameter if it is determined that there is no connection identifier supporting the service grade.

In addition, the method for classifying a packet on a mobile terminal adds a packet classifier to the corresponding connection identifier if it is determined that there is the connection identifier supporting the service grade.

The present invention has the following effects.

The present invention can perform high-speed data processing without being a cause in performance delay on the SDR terminal by designing the general-purpose packet classifier that can be used while allowing change in its own shape by using a configuration manager according to wireless data communication services driven on the SDR terminal and designing the packet classifier, which is a management subject of traffic data, to dynamically generate or remove the packet classifier based on configuration information according to the QoS grade and applications.

### BRIEF DESCRIPTION OF THE DRAWINGS

FIG. 1 is a logical structure diagram of an SDR terminal for explaining an embodiment of the present invention;

FIG. 2 is a diagram showing a configuration for explaining an operation of an SDR software application component;

FIG. 3 is a diagram showing a configuration of a packet classifier component for explaining the embodiment of the present invention;

FIG. 4 is a diagram showing a buffer operating configuration according to the embodiment of the present invention;

FIG. 5 is a diagram for explaining a method for installing the packet classifier components according to the embodiment of the present invention;

FIG. 6 is a block diagram showing the service rule profile for generating the packet classifier according to the embodiment of the present invention;

FIG. 7 is a block diagram showing the rule profile of the packet classifier according to the embodiment of the present invention; and

FIG. 8 is a diagram for explaining a method for generating and adding the packet classifier components according to the embodiment of the present invention.

### DETAILED DESCRIPTION OF THE PREFERRED EMBODIMENTS

The present invention will be described below with reference to the accompanying drawings. Herein, the detailed description of a related known function or configuration that may make the purpose of the present invention unnecessarily ambiguous in describing the present invention will be omitted. Exemplary embodiments of the present invention are provided so that those skilled in the art may more completely understand the present invention. Accordingly, the shape, the size, etc., of elements in the drawings may be exaggerated for explicit comprehension. Like reference number indicates like components throughout the drawings.

Hereinafter, a method for generating a packet classifier and a method for classifying a packet on a mobile terminal according to one embodiment of the present invention will be described in detail. Hereinafter, a multi mode software defined radio (SDR) terminal will be described by way of example.

First, the present invention configures packet classifier components that is focused at the provision of a function to classify IP packet data, which are traffic data, and to satisfy a user desired quality such as in the case where a wireless communication system supports high-speed and low-speed communication services to control port communication that generates many overheads at the time of data communication in a middleware based SDR system, thereby increasing the efficiency of the SDR system. In the mobile terminal, the traffic may be largely divided into real time data necessary for real time services and non real time data, which is subdivided according to each service.

For example, a mobile WiMAX is divided into four service grades, such as an unsolicited grant service (UGS), a real time polling service (rtPS), a non real time polling service (nrtPS), and a best effort (BE) service.

The UGS is used when a periodic transmission of small data such as voice over internet protocol (VoIP) is requested and the rtPS is used when data having a periodically varying size, like a moving picture experts group (MPEG) video, is requested. The nrtPS is used when a data burst having a varying size like a file transfer protocol (FTP) is requested and the BE is used when traffic having a low priority like email or web browsing is processed. The service grade is connected to the service quality parameter such as traffic rate, jitter, maximum latency, error rate, etc., to form the specific connection. In addition, there may be several connections between a terminal and a base station according to QoS, which are divided by the connection identifier.

Meanwhile, since the SDR terminal provides several wireless communication services including portable Internet in one terminal, a function of classifying several services required in the terminal to meet each communication protocol is needed.

Since the data terminal commonly uses these functions, a terminal, which provides several wireless services like the SDR terminal, designs a basic function and is used while changing its own shape, such that the efficiency of the terminal can be increased. In the mobile Internet, the IP packet data between the terminal and the base station can be transmitted and received by only the specific connection set in the lower transmission layer and mapping of the packet data of the IP layer to the specific connection identifier of the lower transmission layer is performed by the packet classifier.

The packet classifier is an apparatus for classifying the IP packet data by specific connection of the lower transmission layer based on the header information of the IP packet data transmitted from the upper layer, wherein the terminal requires an uplink packet classifier for classifying all uplink packets toward the base station and the base station requires a downlink packet classifier for classifying all downlink packets toward the terminal.

Several packet classifiers having the same service grade may be generated in one connection between a terminal and a base station. For example, two packet classifiers for the mail or web browsing packet having the same service grade may be mapped by one connection. As described above, adding the new packet classifier to the predetermined connection identifier is performed through a predetermined procedure.

Meanwhile, the packet classifier classifies packets based on the header information of the IP packet. In other words, the IP header field is configured to include a type of service (ToS), a destination address, a source address, a destination port number, a source port number, a protocol type, etc., and the packet classifier classifies the IP packet data by one thereof or a combination of several fields.

For example, when the VoIP packet is input, the packet classifier capable of identifying that the current packet is the VoIP packet by the VoIP header information is required. As a result, the corresponding packet can be transmitted by the connection identifier having the UGS service grade. Otherwise, since the VoIP packet can be transmitted as a best effort service (BE) like HTTP, the service quality cannot be secured. According to the related art, since the packet classifier cannot have an effect on the port setting on the middleware, the packet classifier may be considered as the factors of the transmission delay.

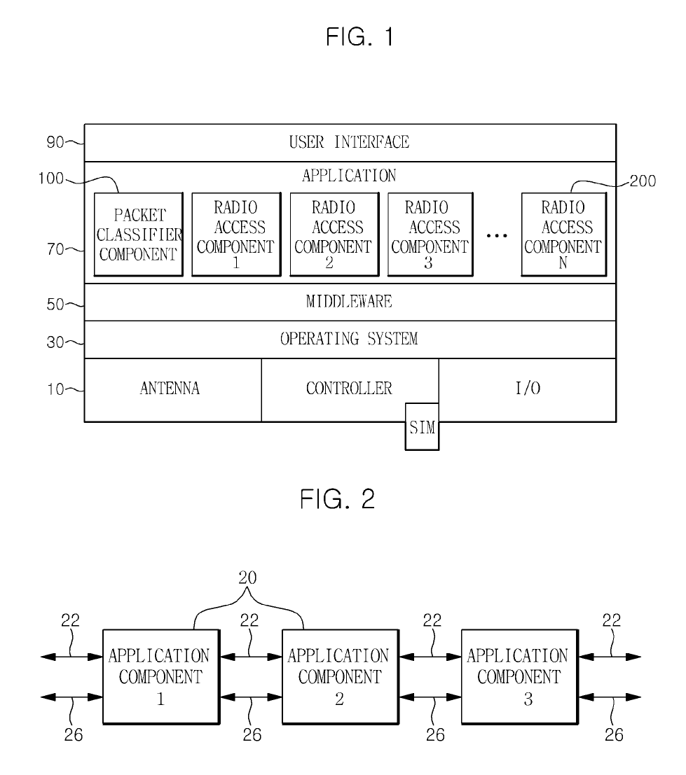

FIG. 1 is a diagram for explaining a logical structure of an SDR terminal to which the present invention is applied.

The SDR terminal to which the present invention is applied includes an antenna for radio access, a controller that includes a DSP and a general-purpose processor, an I/O interface, a hardware device 10 like an SIM card that stores user information. The SIM card is configured to be removable and is accessed by a standard interface. The I/O interface, which is a device including a typical terminal, includes a general-purpose interface such as a USB, a PCMCIA, etc., and is provided in an LAN type or a wireless LAN type in the case of a notebook PC or a PDA environment. The SDR terminal according to the present invention is provided with a radio access component 200 through these devices and is used upon performing a download through a wired device or other devices when it is difficult to perform a download through wireless.

An operating system 30 for operating a terminal is installed on the hardware device 10 and middleware 50 for efficiently operating the SDR terminal that is installed thereon. An application 70, which includes a packet classifier component 100 and one or more radio access component 200, is commonly installed on the middleware 50.

The radio access components 10 are positioned in a fixed memory on the terminal and are driven to provide services selected by the user through a user interface 90 to perform radio access.

FIG. 2 is a diagram showing a configuration for explaining an operation of an SDR software application component.

Referring to FIG. 2, each software application component 20 (hereinafter, ‘application component’), which is provided from a network, provides a port 22 and an internal interface 26 that are provided so as to be a standard for each component in a communication scheme between the components. The port 22 should follow a standard to communicate with the middleware and other application components through CORBA communication by using a standardized scheme. The internal interface 26 increases software recycling by the communication scheme provided together with shape information upon designing the components, which is designed to perform high-speed interface, and has the internal interface format such as IPC, etc. The application components, which is communicated by using the internal interface 26, are integrated in one component on the middleware and then are used.

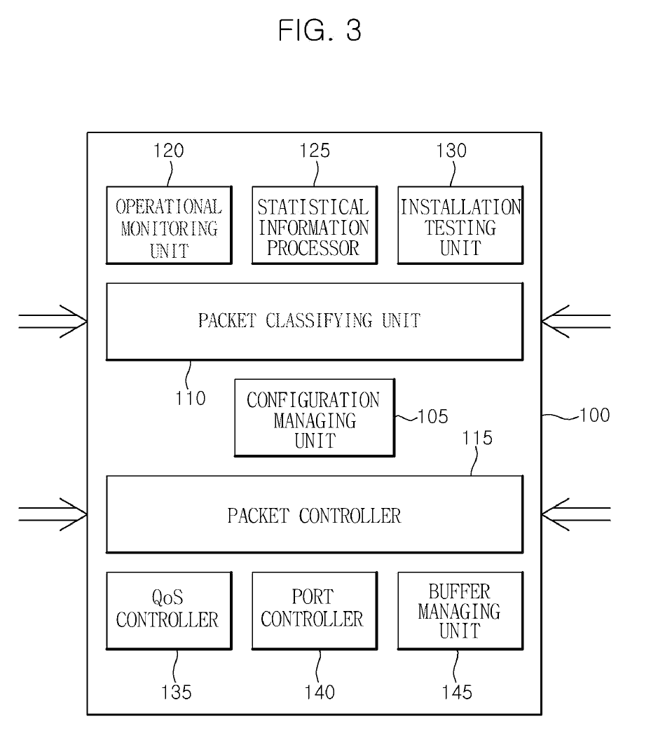

FIG. 3 is a diagram showing a configuration of a packet classifier component for explaining the embodiment of the present invention.

Referring to FIG. 3, the packet classifier component 100 (hereinafter, ‘packet classifier’) is configured of functional blocks that plays a role of each function, as shown in FIG. 3.

The user sets the functions of the packet classifier through a configuration managing unit 105 in order to use the packet classifier components. It largely includes QoS grade classification and channel including an interface between components and connection setting.

The packet classifier 100 having the basic configuration receives QoS information according to a communication system to be currently serviced and thus, the shape information is configured to have an input and output, an internal channel, and a buffer system.

The packet classifier 100 performs packet classification and control function through a packet classifying unit 110 and a packet controller 115. In the standard of the mobile WiMAX, etc., these functions are performed in the convergence layer, which may be considered as one example where the protocol layers of the functional components are applied.

The packet classifier 100 according to the present invention provides the control information of the port in the convergence layer that handles the typical IP packet data in order to efficiently perform the functions of the components requested in the SDR terminal including the middleware. Further, the packet classifier 100 includes the functional blocks for this.

The packet classifying unit 110 processes all traffic data and thus, monitors whether the data packets according to the QoS are appropriately processed through the operational monitoring function in an operational monitoring unit 120.

When the user or the system requests operational monitoring results through a statistical information processor 125, the packet classifying unit 110 provides that.

When an installation testing unit 130 installs components under the control of the middleware, it generates the IP packet data and thus, provides a function capable of testing communication with an upper or lower end.

The QoS controller 135 applies the QoS grade received from the configuration managing unit 105 to control the priority of the packet classifier, thereby managing the substantial QoS requested in the service.

The port controller 140 provides the traffic information requested in the SDR middleware to the installation manager and provides the related information in order not to delay the port.

A buffer managing unit 145 operates buffers for each service layer, which is basic functions on the packet classifier, according to the control information, thereby making it possible to perform the QoS function.

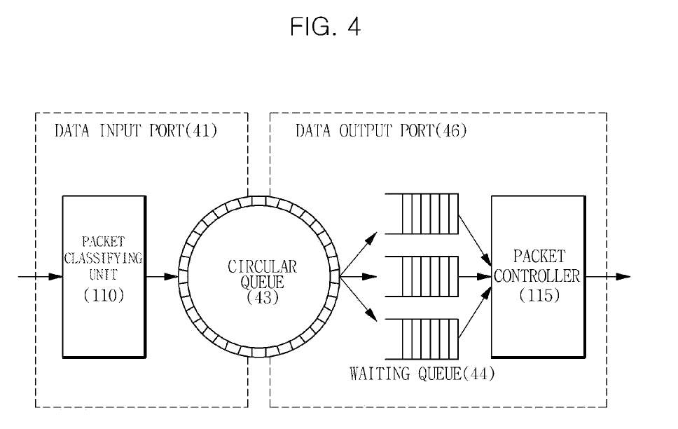

FIG. 4 is a diagram showing a buffer operating configuration according to an exemplary embodiment of the present invention.

FIG. 4 shows packet processing steps on the packet classifier and shows a case where they are applied to the downlink. However, the present invention is not limited thereto and those skilled in the art can easily derive the fact that the present invention can be applied to the uplink through FIG. 4 and the description corresponding thereto.

The IP data input to the packet classifier components through a data input port 41 is classified for each QoS through the packet classifying unit 110, which are input for each waiting queue 44 classified according to the QoS through a circular queue 43.

The data input to each buffer are transferred to other components through a data output port 46 by the priority control of the packet controller 115.

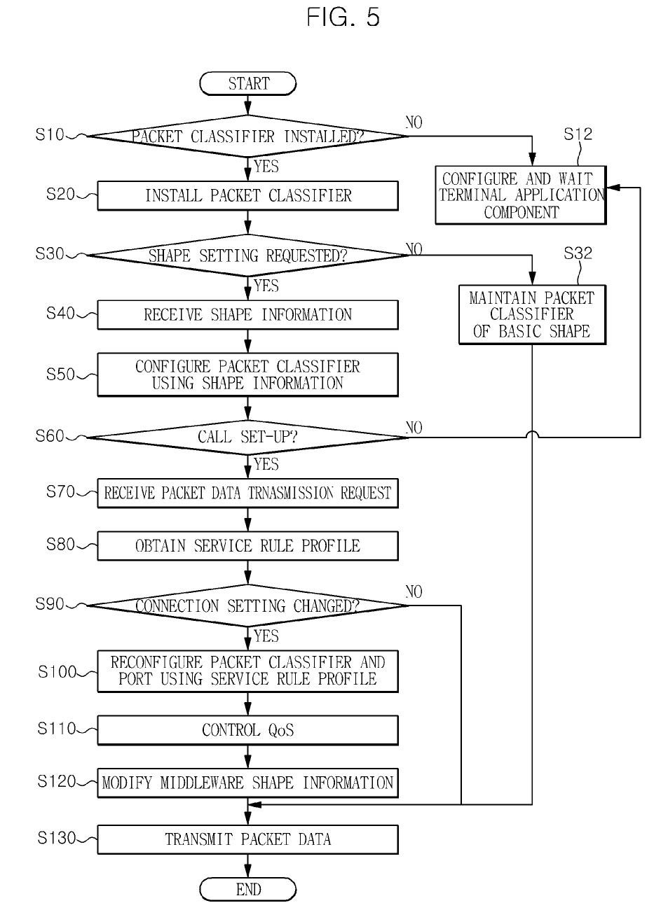

FIG. 5 is a diagram for explaining a method for installing and generating the packet classifier components according to the embodiment of the present invention.

Referring to FIG. 5, when the SDR terminal is driven, it configures the basic packet classifier component and determines whether the basic packet classifier components are installed by the middle (S10). In the case of the non-installed services, it configures other SDR terminal application components and then, waits for the services (S12).

In the case of the application services including the packet classifier components, it installs the configured packet classifier on the SDR terminal (S20) and determines whether shape setting is requested (S30).

As the determination result at step S30, if it is determined that shape setting for the packet classifier components is requested, it receives the shape information (S40) and thus, configures the packet classifier components (S50). When all the application components including the packet classifier components (hereinafter, ‘packet classifier’) configuring the services are configured, it waits for a call-setup (S60).

Meanwhile, as the determination result at step S30, if it is determined that the shape setting for the packet classifier components is not requested, it performs the transmission function of the IP packet data in the basic packet classifier component type and maintains the existing shape (S32) and is operated under the middleware control as the application components.

When the transmission of the IP packet data starts (S70) by the call set-up (S60) that attempts the radio access to the SDR terminal configured after the shape setting (S50), it obtains the service grade and the service quality parameter of the IP packet data from the specific service rule profile to confirm whether the connection setting according to the QoS grade is changed (S80 and S90), wherein the service rule profile includes the service grade and the service quality parameter.

Next, it reconfigures the packet classifier and the port using the service grade and the service quality parameter obtained at step S80 and starts the QoS control (S110) and progresses the data transmission when the information is not changed. At this time, the service rule profile may further include an identifier, a protocol type, and a server side port number. The present invention confirms the connection identifier that supports the service grade obtained from the service rule profile through this and then, adds the packet classifier and the port to the corresponding connection identifier when there is the connection identifier supporting the service grade and generates the packet classifier corresponding to the service grade when there is no connection identifier supporting the service grade.

When the packet classifier configuration is changed, it transmits the information to the middleware to modify the information (S120) and transmits the IP packet data received from the upper layer (S130).

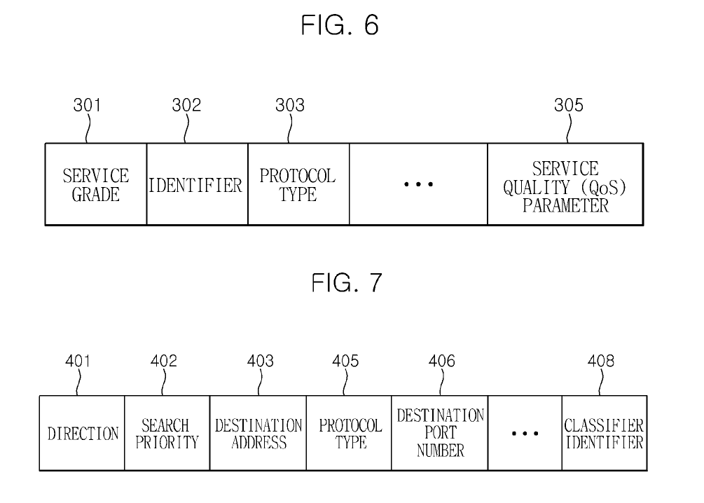

FIG. 6 is a block diagram showing the service rule profile for generating the packet classifier according to the embodiment of the present invention.

The service rule profile, which is the input information of the configuration managing unit (see FIG. 3) includes a service grade 301 field according to the QoS, an identifier 302 field, a protocol type 303 field, and a service quality parameter 305 field, as shown in FIG. 6.

According to the embodiment of the present invention, the packet classifier of the present invention has the function of controlling the buffer according to the priority. The packet classifier substitutes the service rule profile of FIG. 6 to apply the QoS grade requested in the service, thereby processing data. First, the service grade 301 may be largely divided into real time data and non real time data, which may be divided into several grades according to the services and the identifier 302 indicates an identifier that may be classified according to the grade.

The protocol type 303 classifies a protocol type of a transmission control protocol (TCP) or a user datagram protocol (UDP), etc., and the service quality parameter 305 is configured of parameters requested in the service such as response time, delay time, etc.

FIG. 7 is a block diagram showing the rule profile of the packet classifier according to the embodiment of the present invention.

As shown in FIG. 7, the rule profile of the packet classifier according to the embodiment of the present invention includes a direction 401 field that indicates an up direction/down direction, a search priority 402 field, a destination address 403 field, a protocol type 405 field, a destination port number 406 field, and a classifier identifier 408 field. Among those, the search priority 402 is to define a search order of N packet classifiers.

The packet classifier having the rule profile of the above-mentioned configuration is positioned at the terminal and when the terminal receives the packet transmission requesting signal, finds out the connection identifier (302 of FIG. 6) corresponding thereto using the rule profile of the packet classifier shown in FIG. 7.

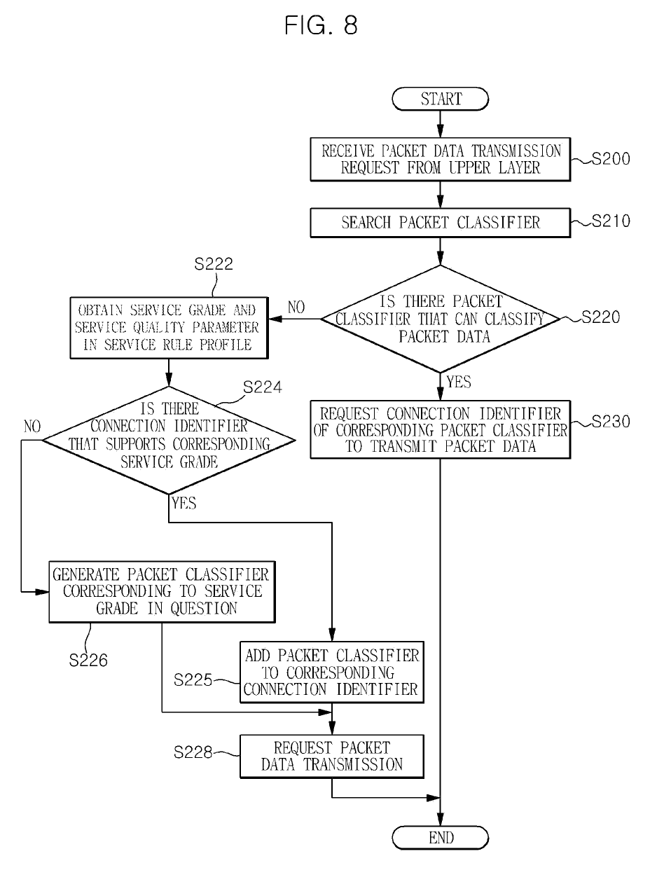

FIG. 8 is a diagram for explaining a method for generating and adding the packet classifier according to the embodiment of the present invention.

Referring to FIG. 8, when the IP packet data (hereinafter, ‘packet’) transmission request is received from the upper layer (S200), the terminal searches whether there is the uplink packet classifier that can classify the corresponding packet (S210).

As the search result at step S210, if it is determined that there is the uplink packet classifier that classifies the corresponding packet, it request the packet transmission to the connection identifier corresponding thereto (S230).

However, if it is determined that there is no uplink packet classifier that classifies the corresponding packet, it perform a procedure for generating a new packet classifier.

The procedure for generating the new packet classifier is as follows.

First, the service grade and the service quality parameter information are extracted in the service rule profile (S222). It searches whether there is the connection identifier that supports the corresponding service grade (S224).

As the search result at step S224, if it is determined that there is the connection identifier that supports the corresponding service grade, it starts a procedure for adding the packet classifier to the corresponding connection setting (S225).

If it is determined that there is no connection identifier that supports the corresponding service grade, it starts a procedure for generating a new service flow (S226).

When the procedure for generating the new service flow starts, it uses the obtained service grade and service quality parameter from step S222. At this time, the data generating the service flow is transmitted to the next component by the data transmission request (S228) and the packet no having information is discarded.

Meanwhile, although FIG. 8 is illustrated based on the procedure for generating and adding the uplink packet classifier positioned at the terminal, the present invention is not limited thereto and the same operational principle can be applied to the procedure for generating and adding the downlink packet classifier positioned at the base station.

In other words, when the base station receives the packet data transmission request in the upper layer at step S200, it searches whether there is the downlink packet classifier that can classify the corresponding packet at step S210. The subsequent procedures are the same as the terminal and therefore, the repeated description will be omitted.

Some steps of the present invention can be implemented as a computer-readable code in a computer-readable recording medium. The computer-readable recording media include all types of recording apparatuses in which data that can be read by a computer system is stored. Examples of the computer-readable recording media include a ROM, a RAM, a CD-ROM, a CD-RW, a magnetic tape, a floppy disk, an HDD, an optical disk, an optical magnetic storage device, etc., and additionally include a recording medium implemented in the form of a carrier wave (for example, transmission through the Internet). Further, the computer-readable recording media are distributed on computer systems connected through the network, and thus the computer-readable recording media may be stored and executed as the computer-readable code by a distribution scheme.

As described above, the exemplary embodiments have been described and illustrated in the drawings and the description. Herein, specific terms have been used, but are just used for the purpose of describing the present invention and are not used for qualifying the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A method for classifying a packet on a mobile terminal, comprising:
receiving a transmission request of IP packet data from an upper layer;
determining whether there is a packet classifier for classifying the IP packet data;
generating the packet classifier by obtaining a service grade and a service parameter for the IP packet data if it is determined that there is no packet classifier for classifying the IP packet data; and
requesting a connection identifier of the generated packet classifier to transmit the IP packet data.

2. The method for classifying a packet on a mobile terminal according to claim 1, wherein the generating the packet classifier is performed by
obtaining a service grade and a service quality parameter of the IP packet data from a service rule profile; and
generating the packet classifier using the obtained service grade and service quality parameter.

3. The method for classifying a packet on a mobile terminal according to claim 2, wherein the service rule profile further includes an identifier, a protocol type, and a server side port number.

4. The method for classifying a packet on a mobile terminal according to claim 2, wherein the generating the packet classifier using the obtained service grade and service quality parameter is performed by
determining whether there is the connection identifier supporting the service grade obtained from the service rule profile; and
newly generating a packet classifier using the obtained service grade and service quality parameter if it is determined that there is no connection identifier supporting the service grade.

5. The method for classifying a packet on a mobile terminal according to claim 4, further comprising adding a packet classifier to the corresponding connection identifier if it is determined that there is the connection identifier supporting the service grade.

6. The method for classifying a packet on a mobile terminal according to claim 1, further comprising
requesting the corresponding connection identifier to transmit the IP packet data, if it is determined that there is the packet classifier for classifying the IP packet data.

7. A method for generating a packet classifier on a mobile terminal, comprising:
receiving a transmission request of IP packet data from an upper layer;
obtaining a service grade and a service quality parameter for the IP packet data from a specific service rule profile; and
generating a packet classifier using the obtained service grade and service quality parameter.

8. The method for generating a packet classifier on a mobile terminal according to claim 7, wherein the service rule profile further includes an identifier, a protocol type, and a server side port number.

9. The method for generating a packet classifier on a mobile terminal according to claim 7, wherein the generating the packet classifier is performed by
determining whether there is the connection identifier supporting the service grade obtained from the service rule profile; and
generating a packet classifier using the obtained service grade and service quality parameter if it is determined that there is no connection identifier supporting the service grade.

10. The method for generating a packet classifier on a mobile terminal according to claim 9, further comprising
adding a packet classifier to the corresponding connection identifier if it is determined that there is the connection identifier supporting the service grade.
